(19) United States
(12) Patent Application Publication
(10) Pub. No.: US 2025/0376013 A1
(43) Pub. Date: Dec. 11, 2025

(54) ARRANGEMENT FOR A VEHICLE ROOF, AND VEHICLE ROOF

(71) Applicant: Webasto SE, Stockdorf (DE)

(72) Inventor: Sebastian GERING, Stockdorf (DE)

(21) Appl. No.: 19/226,863

(22) Filed: Jun. 3, 2025

(30) Foreign Application Priority Data
Jun. 6, 2024 (DE) 10 2024 115 823.9

(51) Int. Cl. B60J 7/043; B60J 7/057

(52) U.S. Cl. CPC B60J 7/0435; B60J 7/0573

(57) ABSTRACT

An arrangement for a vehicle roof having a roof opening has a guide rail which is elongate along a longitudinal direction, a cover having a cover support which is elongate along the longitudinal direction, the cover being displaceable relative to the guide rail and in a closed position being designed to close the roof opening, the cover support having a protrusion which protrudes along a transverse direction aligned transversely to the longitudinal direction, and the guide rail having a clearance, the protrusion and the clearance in the closed position being disposed so as to be mutually opposite along the transverse direction in such a way that the protrusion by means of a deflection along the transverse direction is able to be brought to engage with the clearance.

### CROSS-REFERENCE TO RELATED APPLICATION(S)

This application claims the benefit of DE Application No. 10 2024 115 823.9, filed Jun. 6, 2024, which is incorporated herein by reference in its entirety.

### TECHNICAL FIELD

Specified is an arrangement for a vehicle roof having a roof opening, in particular an arrangement having a displaceable cover. Moreover specified is a vehicle roof, in particular a vehicle roof having an arrangement of this type.

### BACKGROUND

Arrangements having a movable cover for a vehicle roof can be embodied as a so-called externally guided sliding roof, as described in DE 197 13 347 C1, for example. Alternatively, it is also possible to embody the vehicle roof as a so-called spoiler roof, as described in DE 10 2012 106 545 A1, for example.

It is desirable to specify an arrangement for a vehicle roof, which enables a reliable operation. It is furthermore desirable to specify a vehicle roof which enables a reliable operation.

### SUMMARY

The disclosure relates to an arrangement for a vehicle roof. The vehicle roof has a roof opening. The arrangement has a guide rail which is elongate along a longitudinal direction. The arrangement has a cover. The cover has a cover support which is elongate along the longitudinal direction. The cover is displaceable relative to the guide rail. The cover is in particular coupled to the guide rail in such a way that the cover is held in the guide rail and is longitudinally displaceable relative to the guide rail. In a closed position, the cover is designed to close the roof opening. In additional positions, in particular in an open position in which the cover is displaced along the longitudinal direction in comparison to the closed position, the roof opening is at least partially exposed.

The cover support has a protrusion. The protrusion protrudes along a transverse direction aligned transversely to the longitudinal direction. The guide rail has a clearance. The protrusion and the clearance in the closed position are disposed so as to be mutually opposite along the transverse direction. The protrusion and the clearance are disposed so as to be mutually opposite one another in such a way that the protrusion by means of a deflection along the transverse direction is able to be brought to engage with the clearance.

The cover is coupled to the guide rail, for example, by means of a tilting mechanism. In particular, the tilting mechanism is fastened to the cover support. For example, the tilting mechanism has a slide which for driving the tilting mechanism is guided so as to be longitudinally displaceable in the guide rail. The cover, by means of the tilting mechanism, is able to be lifted and lowered along a vertical direction relative to the guide rail, for example, and is displaceable along the longitudinal direction so as to selectively expose and close the roof opening. The slide is coupled to an electric motor, for example, by means of a drive cable which is rigid under tension and compression.

The longitudinal direction, the transverse direction and the vertical direction are in particular in each case mutually perpendicular.

In addition to the coupling by means of the tilting mechanism, an additional safeguard for holding the cover on the guide rail is formed by means of the protrusion and the clearance. In particular in the event of high forces which are directed from the inside to the outside along the vertical direction in relation to the vehicle, the protrusion comes to engage with the clearance in such a way that the cover support by means of the protrusion has an additional latching mechanism in relation to the guide rail. In this way, the cover is held on the guide rail by means of the tilting mechanism, and additionally by means of the protrusion interlocking in the clearance.

In movements of the cover and of the cover support relative to the guide rail for lifting and lowering the cover, and/or for longitudinally displacing the cover, under normal operating conditions the protrusion is not disposed in the clearance, and the protrusion can in particular be moved along the longitudinal direction relative to the guide rail so as to bypass the clearance. For example in the event of an accident, and in particular when airbags of the vehicle are triggered, in particular all airbags of the vehicle are triggered at once, the great forces which are directed from the vehicle interior toward the outside can act on the cover. In particular in the case of a closed cover, forces of 7500 up to 10,500 N/m2 act in the process, for example. In this case, it is possible that the cover is forced toward the outside, in particular in a cover central region. It is possible herein that the guide rail is pivoted and/or deformed, for example pivoted about the longitudinal direction. In order to implement an additional safeguard, in addition to the tilting mechanism, for holding the cover and the cover support on the guide rail, the protrusion and the clearance are provided, which come to engage with one another when the cover support is pivoted and/or deformed, and additionally hold the cover support on the guide rail.

In this way, it can be reliably avoided that the cover and the cover support are detached from the guide rail and the vehicle roof. In particular in the case of comparatively large covers with cover areas of up to 2 m2 or more, the cover and the cover support can thus be reliably held on the guide rail. It is thus avoidable that the cover support disengages from the guide rail. When the protrusion engages in the clearance, the cover support is reliably locked in the vertical direction relative to the guide rail.

According to at least one embodiment, the guide rail has a wall portion which has a main extent along a plane defined by the longitudinal direction and the vertical direction. The clearance is disposed in the wall portion. In this way, the clearance is able to be implemented with an efficient utilization of installation space. The wall portion is in particular disposed on a side of the guide rail that faces the cover central region. The cover central region is in particular a region which is spaced apart from the lateral edges of the cover and extends about the center of the cover. The wall portion is disposed on a side of the guide rail that faces inward along the transverse direction. This enables the protrusion to be reliably introduced into the clearance in the event of the above-described deflection of the cover support.

According to at least one embodiment, the protrusion protrudes in the direction toward the cover central region. The protrusion protrudes along the transverse direction. In this way, the protrusion protrudes in the direction in which it is also moved when the above-described twisting of the cover support takes place. This enables the protrusion to be reliably introduced into the clearance.

According to at least one embodiment, the protrusion has a longitudinal extent along the longitudinal direction of more than 0.5 cm, for example more than 4 cm, and less than 10 cm, for example between 5 mm and 10 mm. According to embodiments, the protrusion has a transverse extent along the transverse direction of more than 0.5 mm and less than 11 mm, for example between 1 mm and 10 mm. The thickness along the vertical direction is, for example, between 1.5 mm and 3 mm, for example 2.5 mm. The size of the protrusion is in particular a function of the available installation space and/or of the cover size and the resultant potential forces arising here.

The size of the clearance is pre-defined so as to correspond to the size of the protrusion in such a way that it is possible to reliably introduce the protrusion into the clearance.

For example, the protrusion is disposed in the region of the rear edge of the cover. The region of the rear edge of the cover is in particular a region which, proceeding from the rear edge, extends at most up to 50% of the cover along the longitudinal direction. For example, the rear edge of the cover is the edge that in the operative state faces away from a windshield of the vehicle and faces a rear window. Accordingly, the clearance is disposed in a rear region of the guide rail, for example. Alternatively or additionally, the protrusion is disposed in the region of the front edge of the cover. Alternatively or additionally, the protrusion is disposed in the region of the center of the cover.

According to one embodiment, the arrangement has a plurality of protrusions on the cover support. For example, the arrangement has a plurality of clearances in the guide rail. One protrusion of the protrusions and one clearance of the clearances are in each case assigned to one another. In this way it is possible, for example, to implement the latching between the cover support and the guide rail by means of a plurality of protrusions. In this way, the latching is able to be reliably implemented even in the case of high forces.

According to one embodiment, a vehicle roof having a roof opening has an arrangement according to at least one of the embodiments described here. The vehicle roof is in particular a vehicle roof for a motor vehicle. The guide rail is fixed so as to be stationary on a bodywork of the vehicle roof. In this way, it is possible by means of the protrusion and the clearance to hold the cover and the cover support on the bodywork of the vehicle by means of the guide rail, should the above-described forces arise and the guide rail is correspondingly pivoted or twisted.

According to one embodiment, the protrusion protrudes along the transverse direction away from the bodywork. For example, the wall portion of the guide rail is disposed on a side of the guide rail that faces away from the bodywork along the transverse direction. When the guide rail is twisted or pivoted when the above-described forces arise, the protrusion is moved along the transverse direction away from the bodywork and thus comes to reliably engage with the clearance of the guide rail.

Further advantages, features and refinements are derived from the following examples which are explained with reference to the figures. Elements which are identical, of identical type and of identical function can be provided with the same reference signs in all figures.

### BRIEF DESCRIPTION OF DRAWINGS

In the figures:

FIG. 1 shows a schematic illustration of part of a vehicle according to an exemplary embodiment;

FIGS. 2 and 3 each show schematic illustrations of an arrangement according to an exemplary embodiment in different operative states;

FIG. 4 shows a schematic illustration of a cover support according to an exemplary embodiment; and

FIG. 5 shows a schematic illustration of a guide rail according to an exemplary embodiment.

### DETAILED DESCRIPTION

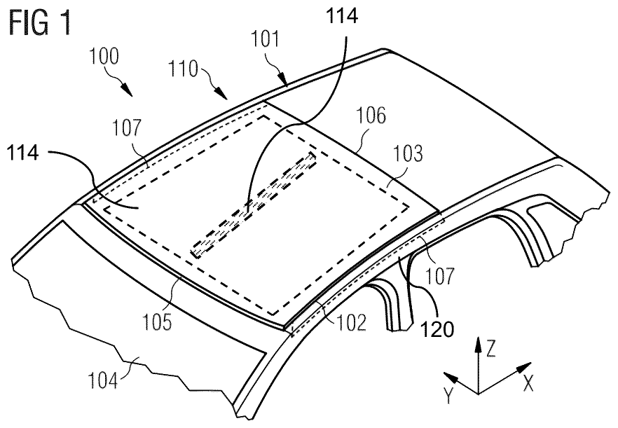

FIG. 1 shows a schematic illustration of a vehicle roof 101 of a vehicle 100. The vehicle 100 is, for example, a passenger motor vehicle. The vehicle roof has an arrangement 110. The arrangement 110 has a cover 103. The cover 103 serves to close a roof opening 102 of the vehicle roof 101. By means of displacing the cover 103 along the longitudinal direction X, the roof opening 102 is able to be closed in a closed position, and able to be at least partially exposed in an open position. For this purpose, the cover 103 is displaceable relative to a fixed roof part of the vehicle roof 101 along the longitudinal direction X and a vertical direction Z, aligned transversely to the latter, between the closed position, which is illustrated in FIG. 1, and an open position. For closing when proceeding from the open position, the cover is moved counter to the longitudinal direction X.

The cover 103 has a front edge 105 and a rear edge 106. The rear edge 106 is disposed opposite thereto along the longitudinal direction X of the front edge 105 of the cover 103. The front edge 105 faces a windshield 104 of the vehicle 100.

The arrangement 110 has two guide rails 107. The guide rails 107 are in each case elongate along the longitudinal direction X. The guide rails 107 are in each case disposed along the transverse direction Y so as to be next to the roof opening 102, and are connected to a bodywork 120 of the vehicle 100, for example screwed and/or adhesively bonded thereto.

In particular, the arrangement 110 is constructed identically, in particular so as to be mirror-symmetrical and mutually corresponding, on both sides of the roof opening 102. Therefore, one side will be described hereunder, and the opposite side along the transverse direction Y is of a correspondingly identical design.

Positional and/or directional terms used in the context of this disclosure, such as rear or front, relate to the longitudinal direction X, in particular when the arrangement 110 is installed as intended in the vehicle roof 101. The longitudinal direction X may also be called the vehicle longitudinal direction and/or the X direction. Corresponding positional and/or directional terms, such as top or bottom, relate to the vertical direction Z. The vertical direction Z may also be called the height direction or Z direction. Positional and/or directional terms used, such as side or left or right, relate to the transverse direction Y, which may also be called the vehicle transverse direction and/or the Y direction. The longitudinal direction X, the transverse direction Y and the vertical direction Z are each perpendicular to one another.

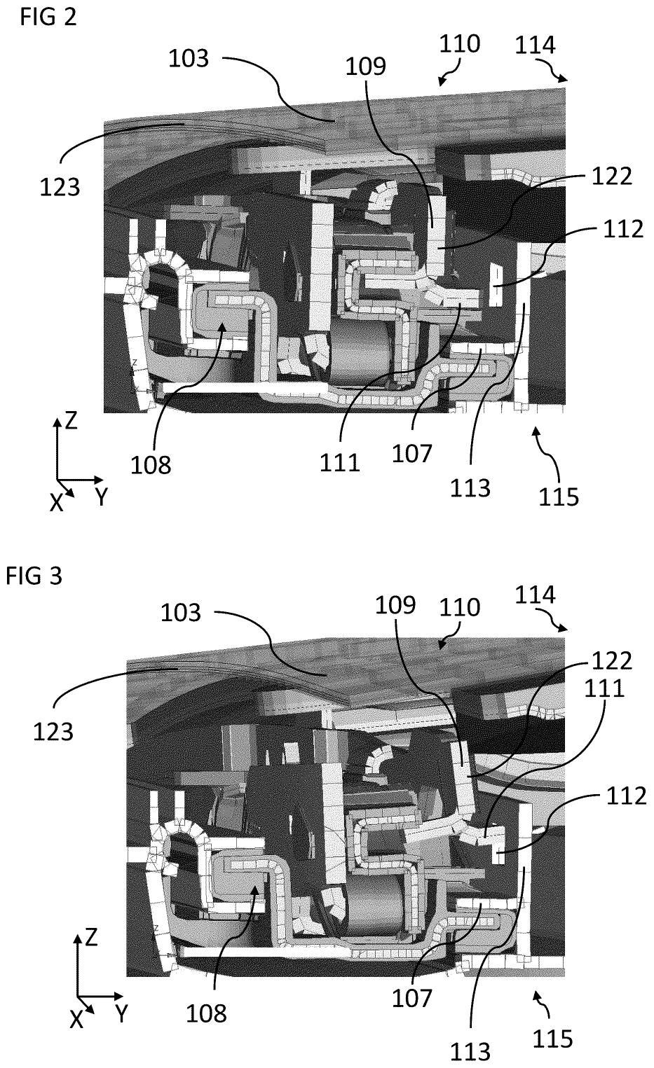

FIGS. 2 and 3 show in each case schematic sectional views of the arrangement 110 in different operative states. FIG. 2 shows the arrangement 110 in the intended state in which the cover 103 can be pivoted and displaced relative to the guide rail 107 as intended.

FIG. 3 shows the arrangement 110 after forces have acted on the cover 103 in the Z direction.

The cover 103 is coupled to the guide rail 107 by means of a tilting mechanism 108. The tilting mechanism 108 can be designed in different ways and enables in particular the relative movement between the cover 103 and the guide rail 107, driven by a drive (which is not explicitly illustrated). For example, the tilting mechanism 108 is embodied in the fashion of a so-called externally guided sliding roof. A rear tilting lever, which is assigned to the rear edge 106, during operation is displaced conjointly with the cover 103 relative to the remaining vehicle roof 101 and in particular relative to the guide rail 107, when the cover 103 is moved between the closed position and the open position. According to additional examples, the tilting mechanism 108 is embodied in the fashion of a so-called spoiler roof, in which the cover 103 during the movement between the open position and the closed position is displaced relative to the rear tilting lever.

The cover 103 is coupled to the tilting mechanism 108 and to the guide rail 107 by means of a cover support 109. The cover support 109 extends so as to be elongate along the longitudinal direction X. The cover support 109 is connected, for example screwed and/or foam-bonded, to a panel 123 of the cover 103, for example a glass panel or a plastic panel, which is in particular transparent and/or translucent.

The cover support has a protrusion 111. The protrusion 111 protrudes along the transverse direction Y. The cover support 109 has an assembly region 122 by means of which the cover support 109 is assembled on the panel 123. For example, the assembly region 122 extends mainly along a plane defined by the longitudinal direction X and the vertical direction Z. The protrusion 111 protrudes beyond this assembly region 122 along the transverse direction Y. The protrusion 111 projects transversely to the main extension direction of the cover support 109.

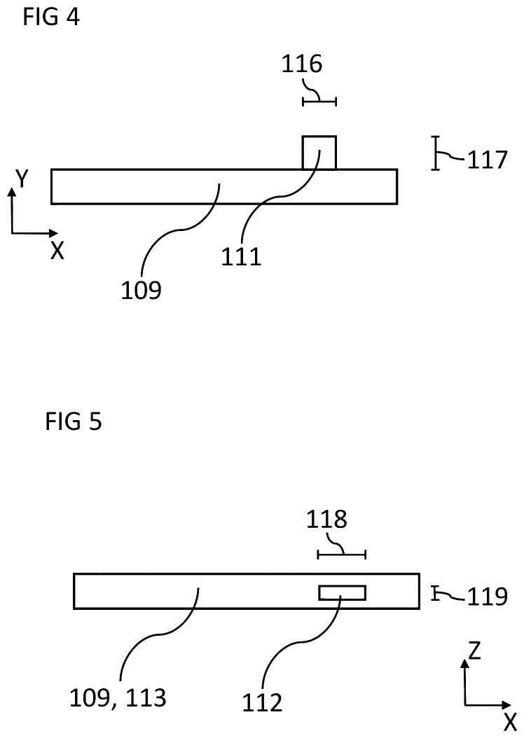

As is derived from FIG. 4, the protrusion 111 has a longitudinal extent 116 along the longitudinal direction X. The protrusion 111 has a transverse extent 117 along the transverse direction Y. For example, the longitudinal extent 116 has a value between 5 mm and 10 mm. Other values are also possible. For example, the transverse extent 117 has a value between 1 mm and 10 mm. Other values of the transverse extent 117 are also possible.

For example, the protrusion 111 is formed from the cover support 109 by means of a bending process so as to implement the protrusion 111 along the transverse direction Y. The protrusion 111 and the assembly region 122 are thus integrally formed, for example. It is also possible that the protrusion 111 and the assembly region 122 are formed as mutually separate components which are fastened to one another by means of a connection, for example a threaded connection, a riveted connection and/or a welded connection.

The protrusion 111 protrudes from the outside toward the inside in the direction of a cover central region 114. The cover central region 114 is a central region of the cover 103 which is in particular spaced apart from the lateral edges and includes a center of the cover 103. The protrusion 111 protrudes along the transverse direction Y, for example in the direction of the second guide rail 107 which is opposite along the transverse direction Y.

The guide rail 107 extends so as to be elongate along the X direction along the roof opening 102. The guide rail 107 is fastened to the bodywork 120. On a side 115 of the guide rail 107, which faces the cover central region 114, the guide rail 107 has a wall portion 113. The wall portion 113 is disposed on the inner side 115 of the guide rail 107. The wall portion 113 extends along a plane which is defined by the longitudinal direction X and the vertical direction Z. The wall portion 113 is in particular vertically aligned.

The wall portion 113 surrounds a clearance 112. In the closed position of the cover 103 illustrated, the clearance 112 is disposed along the transverse direction Y so as to be opposite the protrusion 111. In the closed position, the protrusion 111 and the clearance 112 are mutually opposite. The protrusion 111 faces the clearance 112.

As is derived from FIG. 5, the wall portion 113 surrounds the clearance 112 in such a way that the clearance has a longitudinal extent 118 along the longitudinal direction X, and has a vertical extent 119 along the vertical direction Z. The longitudinal extent 118 and the vertical extent 119 of the clearance 112 are pre-defined in particular as a function of the longitudinal extent 116 and of the transverse extent 117 of the protrusion 111. For example, the longitudinal extent 118 of the clearance 112 has a value which is somewhat larger than the value of the longitudinal extent 116 of the protrusion 111. For example, if the longitudinal extent 116 of the protrusion 111 has a value of 1.5 cm, the longitudinal extent of the clearance 118 has a value of 2 cm, for example. Other values and other value differentials are also possible. The vertical extent 119 of the clearance 112 in particular has a value which enables the movement described hereunder. For example, the vertical extent 119 has a value between 5 mm and 10 mm.

The protrusion 111 and the clearance 112 are in particular disposed in a rear region that faces the rear edge 106. For example, the protrusion 111 and the clearance 112 are disposed closer to the rear edge 106 than to the front edge 105. For example, the protrusion 111 and the clearance 112 are disposed in a region of the cover 103 which, proceeding from the rear edge 106, extends at most over 25% of the overall extent of the cover 103 along the longitudinal direction X. This refers in each case to the closed position of the cover 103.

In the usual operation for lifting and lowering the cover 103, and for displacing the cover 103 between the closed position and the open position relative to the guide rail 107, the guide rail 107 and the cover support 109 are disposed in the closed position as illustrated in FIG. 2. The protrusion 111 passes along the wall portion 113 and the clearance 112 without any engagement taking place.

In a state in which a force acts on the cover central region 114 in the vertical direction Z, thus in a direction from the vehicle interior toward the outside, it is possible that the cover 103 bulges and the guide rail 107 pivots, as is illustrated in FIG. 3. For example, the cover 103 has a transparent region 121 (FIG. 1) in which the cover 103 is designed to be transparent. Disposed outside the transparent region 121 are, for example, the cover support 109, foam moldings or other elements which are used for the operation of the cover 103.

For example, the cover 103 should also be reliably held on the guide rail 107 even at a force of 7500 N/m2 to 10,500 N/m2, for example 9500 N/m2, in terms of the transparent region 121. In this way, it is implemented that no parts detach themselves from the vehicle roof 101 should these forces act from the inside toward the outside on the cover 103. For example, these forces arise in the event of a closed cover, when all airbags of the vehicle are triggered at once. The illustrated pivoting of the cover support 109 between the position illustrated in FIG. 2 and the position illustrated in FIG. 3 arises in particular in the case of comparatively large covers which have a transparent region 121 of more than 0.5 m2, for example of 0.6 m2, 0.7 m2, 1 m2, or more.

The pivoting of the cover support 109 relative to the guide rail 107 has the effect that the protrusion 111 engages with the clearance 112. As illustrated in FIG. 3, the protrusion 111 is in this instance at least partially disposed in the clearance 112. The protrusion 111 extends through the clearance 112 in such a way that the cover support 109 latches to the guide rail 107 by means of the protrusion 111, thus interlocking with the wall portion 113. In this way, the cover support 109 and the guide rail 107 are reliably connected to one another even when the described forces acting from the inside on the transparent region 121 arise, and it is avoided that parts detach themselves. It is avoided that the cover support 109 disengages from the guide rail 107.

The disposal of the protrusion 111 in the clearance 112 blocks in particular a movement of the cover support 109 in the vertical direction Z relative to the guide rail 107. In this way, the protrusion 111 and the clearance 112 provide a safeguard for the arrangement 110 to avoid any undesirable decoupling of the cover support 109 from the guide rail 107 in the event that the cover support 109 pivots about the longitudinal direction X. In this way, the cover 103 is reliably held on the guide rail 107 and on the vehicle roof 101. At increasing forces, and thus with an increasingly bulging cover 103, the protrusion 111 is in particular reliably pushed ever further into the clearance 112, thus forming an ever-increasing resistance in relation to the cover 103 being detached from the arrangement 110.

By means of the protrusion 111 on the cover support 109, and the clearance 112 in the guide rail 107, a reliable safeguard is implemented, which is sufficiently robust to withstand the forces that arise, for example, when all of the airbags of the vehicle 100 are triggered in the event of a closed cover 103. In this case too, the cover 103 is thus reliably held on the vehicle roof 101, and it is reliably avoided that parts detach themselves.

### LIST OF REFERENCE SIGNS

100 Vehicle
101 Vehicle roof
102 Roof opening
103 Cover
104 Windshield
105 Front edge
106 Rear edge
107 Guide rail
108 Tilting mechanism
109 Cover support
110 Arrangement
111 Protrusion
112 Clearance
113 Wall portion
114 Cover central region
115 Side
116 Longitudinal extent of the protrusion
117 Transverse extent of the protrusion
118 Longitudinal extent of the clearance
119 Vertical extent of the clearance
120 Bodywork
121 Transparent region
122 Assembly region
123 Panel
X Longitudinal direction
Y Transverse direction
Z Vertical direction

1. An arrangement for a vehicle roof having a roof opening, comprising
a guide rail which is elongate along a longitudinal direction,
a cover having a cover support which is elongate along the longitudinal direction,
the cover being displaceable relative to the guide rail and in a closed position being designed to close the roof opening,
the cover support having a protrusion which protrudes along a transverse direction aligned transversely to the longitudinal direction, and
the guide rail having a clearance,
the protrusion and the clearance in the closed position being disposed so as to be mutually opposite along the transverse direction in such a way that the protrusion by means of a deflection along the transverse direction is able to be brought to engage with the clearance.

2. The arrangement as claimed in claim 1, wherein the guide rail has a wall portion which has a main extent along a plane defined by the longitudinal direction and a vertical direction aligned transversely to the latter, the clearance being disposed in the wall portion.

3. The arrangement as claimed in claim 2, wherein the wall portion is disposed along the transverse direction so as to be on a side of the guide rail that faces a cover central region.

4. The arrangement as claimed in claim 1, wherein the protrusion protrudes in the direction toward the cover central region.

5. The arrangement as claimed in claim 1, wherein the protrusion has a longitudinal extent along the longitudinal direction of more than 0.5 cm and less than 10 cm, and a transverse extent along the transverse direction of more than 0.5 cm and less than 5 cm.

6. The arrangement as claimed in claim 1, wherein the protrusion and the clearance in the closed position are disposed along the transverse direction so as to be mutually opposite in such a way that the protrusion, by means of a pre-defined force acting on the cover in the direction away from the guide rail, is able to be brought to engage with the clearance.

7. The arrangement as claimed in claim 1, wherein the protrusion and the clearance in the closed position are disposed along the transverse direction so as to be mutually opposite in such a way that the protrusion, by means of pivoting the cover support, is able to be brought to engage with the clearance.

8. The arrangement as claimed in claim 1, having a plurality of protrusions on the cover support, and a plurality of clearances in the guide rail, one protrusion and one clearance being in each case assigned to one another.

9. A vehicle roof having a roof opening having an arrangement as claimed in claim 1, the guide rail being fixed so as to be stationary on a bodywork of the vehicle roof.

10. The vehicle roof as claimed in claim 9, wherein the protrusion protrudes along the transverse direction away from the bodywork.
